(19) United States
(12) Patent Application Publication
(10) Pub. No.: US 2023/0037875 A1
(43) Pub. Date: Feb. 9, 2023

(54) SACCHARIDE FRUIT BEVERAGE HAVING IMPROVED FLAVOR AND METHOD FOR PRODUCING THE SAME

(71) Applicant: KIRIN HOLDINGS KABUSHIKI KAISHA, Nakano-ku, Tokyo (JP)

(72) Inventors: Ryoya SUTO, Nakano-ku, Tokyo (JP); Chiaki NISHIYAMA, Nakano-ku, Tokyo (JP)

(73) Assignee: KIRIN HOLDINGS KABUSHIKI KAISHA, Nakano-ku, Tokyo (JP)

(21) Appl. No.: 17/789,110

(22) PCT Filed: Dec. 18, 2020
(86) PCT No.: PCT/JP2020/047443

§ 371 Date: Jun. 24, 2022

(30) Foreign Application Priority Data
Dec. 27, 2019 (JP) 2019-239789

(51) Int. Cl. A23L 2/52; A23L 2/02; A23L 2/74; A23L 2/84

(52) U.S. Cl. CPC A23L 2/52; A23L 2/02; A23L 2/74; A23L 2/84; A23V 2002/00

(57) ABSTRACT

An object is to provide a novel saccharide-reduced fruit beverage having an improved flavor and a method for producing the same. According to the present invention, provided is a fruit beverage in which a ratio (saccharide concentration-to-acidity ratio) of a saccharide concentration to an acidity is 0.92 or less with respect to a saccharide concentration-to-acidity ratio of a straight fruit juice, the fruit beverage including: one or more carbohydrate components selected from the group consisting of starch, a starch decomposition product, and trehalose, and a method for producing the fruit beverage of the present invention, the method including: adding the carbohydrate components to a saccharide-reduced fruit juice.

### CROSS-REFERENCE TO RELATED APPLICATION

The present application enjoys the benefit of priority from the prior Japanese Patent Application No. 2019-239789 filed on Dec. 27, 2019, the entire disclosure of which is incorporated herein by reference and considered as a part of the present specification.

### TECHNICAL FIELD

The present invention relates to a saccharide-reduced fruit beverage having an improved flavor and a method for producing the same. The present invention also relates to a method for improving a flavor of the saccharide-reduced fruit beverage.

### BACKGROUND ART

With the rise of health consciousness in recent years, it has become desirable for the carbohydrate intake when ingesting foods and drinks to be reduced, and it is also said that reduction in carbohydrate intake will be a social issue in the future. Fruit beverages are widely popular among consumers for maintaining their health because consumers can easily consume fruit thereby. However, since these beverages contain carbohydrates derived from fruit, it can be stated that the content of carbohydrates would desirably be reduced as much as possible from the viewpoint of reducing the carbohydrate intake.

Regarding fruit beverages, techniques for removing monosaccharides or disaccharides from a fruit juice by subjecting the fruit juice to a membrane treatment to reduce calories (Patent Documents 1 and 2) or a technique for treating a fruit juice with fructosyltransferase crude enzyme agent to reduce calories (Patent Document 3) have been proposed.

### REFERENCE LIST

### Patent Documents

Patent Document 1: Japanese Translation of PCT Application No. 2010-520743 Patent Document 2: WO 2006/004106 Patent Document 3: WO 2016/092768

### SUMMARY OF THE INVENTION

The present inventors have recently found that fruit juices, such as fruit juices with a reduced saccharide content (hereinafter, sometimes referred to as “saccharide-reduced fruit juices”), having a lowered ratio of a saccharide concentration to an acidity tend to have a deteriorated flavor balance compared to a straight fruit juice having a general composition, and that the deterioration in the flavor balance due to the reduction in the amount of saccharides can be ameliorated by presence of specific carbohydrate components in the saccharide-reduced fruit juices. The present inventors have also found that the flavor balance further deteriorates due to heat sterilization for packaging saccharide-reduced fruit juices and that the deterioration in the flavor balance due to heat sterilization can also be ameliorated by the presence of specific carbohydrate components in the saccharide-reduced fruit juices. The present invention is based on these findings.

An object of the present invention is to provide a novel saccharide-reduced fruit beverage with an improved flavor and a method for producing the same. Another object of the present invention is to provide a method for improving a flavor of a saccharide-reduced fruit beverage.

According to the present invention, the following aspects are provided.
[1] A fruit beverage in which a ratio (saccharide concentration-to-acidity ratio) of a saccharide concentration to an acidity is 0.92 or less with respect to a saccharide concentration-to-acidity ratio of a straight fruit juice, the fruit beverage including: one or more carbohydrate components selected from the group consisting of starch, a starch decomposition product, and trehalose.
[2] A fruit beverage containing a saccharide-reduced fruit juice, the fruit beverage including: one or more carbohydrate components selected from the group consisting of starch, a starch decomposition product, and trehalose.
[3]The fruit beverage according to [1] or [2] described above, in which a content of carbohydrate components in the beverage is 0.005 to 0.10 mass%.
[4] The beverage according to any one of [1] to [3] described above, in which fruit includes one or more selected from the group consisting of orange, grapefruit, Unshu mikan, and pineapple.
[5] The fruit beverage according to [4] described above, in which an oligosaccharide concentration of the beverage is 0.10 g/100 mL or more in terms of Brix 11°.
[6] The beverage according to any one of [1] to [5] described above, in which a proportion of the fruit juice is 30% or more.
[7] The beverage according to any one of [1] to [6] described above which is a packaged beverage.
[8] A method for producing the fruit beverage according to any one of [1] to [7] described above, the method including: adding one or more carbohydrate components selected from the group consisting of starch, a starch decomposition product, and trehalose to a saccharide-reduced fruit juice.
[9] The production method according to [8] described above, further including: adjusting a content of carbohydrate components in the beverage to 0.005 to 0.10 mass%.
[10] The production method according to [8] or [9] described above, further including: a step of reducing an amount of saccharides of the raw material fruit juice.
[11] The production method according to [10] described above, in which the step of reducing an amount of saccharides is performed by one or more treatments selected from the group consisting of an enzyme treatment, a membrane filtration treatment, a catalyst treatment, and a fermentation treatment.
[12] The production method according to any one of [8] to [11] described above, in which fruit includes one or more selected from the group consisting of orange, grapefruit, Unshu mikan, and pineapple.
[13] A method for improving a flavor of a fruit beverage containing a saccharide-reduced fruit juice, the method including: adding one or more carbohydrate components selected from the group consisting of starch, a starch decomposition product, and trehalose to the beverage.
[14] The method for improving a flavor according to [13] described above, in which the fruit beverage is a packaged beverage.

The beverage of [1] described above and the beverage of [2] described above are sometimes referred to as “beverages of the present invention” in the present specification.

According to the present invention, it is possible to improve flavor balance of a saccharide-reduced fruit beverage which tends to deteriorate. That is, the present invention is advantageous in that a saccharide-reduced fruit beverage (particularly a packaged saccharide-reduced fruit beverage) which has a flavor comparable to that of ordinary fruit juices and is low-calorie can be provided.

### DETAILED DESCRIPTION OF THE INVENTION

### Beverages of Present Invention

A “fruit beverage” in the present invention means a beverage using a fruit juice as a raw material. Examples thereof include fruit juice, mixed fruit juice, fruit granule-containing fruit juice, concentrated fruit juice, and a fruit juice-containing beverage. The beverages of the present invention can be non-alcoholic beverages containing no alcohol. The beverages of the present invention can also be sweetener-free fruit beverages into which no sweeteners (excluding trehalose) such as high-intensity sweeteners have been incorporated, for pursuing having a taste closer to that of natural fruit juices.

Examples of “fruit” in the present invention include citrus fruit such as oranges, grapefruit, and Unshu mikan, and pineapples, apples, grapes, peaches, strawberries, bananas, mangoes, melons, and apricots. Oranges, grapefruit, Unshu mikan, and pineapples can be preferably used.

A “Brix value” (sometimes simply referred to as “Brix” in the present specification) in the present invention is an index indicating a total concentration of soluble solid contents (for example, saccharides, proteins, and peptides) contained in a solution and is a value obtained by converting a refractive index of the solution measured at 20° C. into mass/mass% of a pure sucrose solution using the conversion table of the International Commission for Uniform Methods of Saccharide Analysis (ICUMSA). The refractive index at 20° C. can be measured using a commercially available saccharide refractometer such as a saccharimeter manufactured by Atago Co., Ltd.

“Brix A° conversion” in the present invention means a quantitative value of a beverage obtained by adjusting a Brix value of the beverage to A°. For example, a “fruit beverage having a sucrose concentration of 1.4 g/100 mL or less in terms of Brix 11°” means a fruit beverage having a sucrose concentration of 1.4 g/100 mL or less when a Brix value is adjusted to 11° through dilution or concentration.

“Reduction in the amount of saccharides” in the present invention means that the content of saccharides as raw materials is reduced compared to those of fruit or fruit juices. The reduction in the amount of saccharides can be achieved through treatments of processing a raw material fruit juice, that is, enzymatic treatment, a membrane filtration treatment, a catalyst treatment, a fermentation treatment, and the like, as will be described below. The degree of the reduction in the amount of saccharides can be expressed by a saccharide reduction rate calculated by the following equation. Saccharide reduction rate (%) = {(Saccharide concentration before saccharide reduction treatment - Saccharide concentration after saccharide reduction treatment) / (Saccharide concentration before saccharide reduction treatment)} × 100

A lower limit value of saccharide reduction rates of the beverages of the present invention or saccharide reduction rates of saccharide-reduced fruit juices which are raw materials of the beverages of the present invention can be set to 8%, 16%, or 20%, and an upper limit value thereof can be set to 50%, 75%, or 80%. These lower limit values and upper limit values can be arbitrarily combined, and the range of the above-described rate can be set to, for example, 8 to 50% or 16 to 80%.

“Saccharides” in the present invention means carbohydrates such as monosaccharides and disaccharides. Examples thereof include glucose, fructose, sucrose, and maltose. The saccharide concentration can be measured through high-performance liquid chromatography (HPLC method).

An “acidity” in the present invention means a value calculated based on an acidity measurement method defined in the Japanese Agricultural Standards (Aug. 8, 2006, Ministry of Agriculture, Forestry and Fisheries Notification No. 1127). Specifically, a citric acid conversion value can be used, and the percentage calculated by the following equation can be used as an acidity.
Acidity (%)=A×f×100/W×0.0064
A: Amount (mL) of titration with 0.1 mol/L sodium hydroxide solution
f: Titer of 0.1 mol/L sodium hydroxide solution
W: Sample weight (g)
0.0064: Weight (g) of anhydrous citric acid corresponding to 1 mL of 0.1 mol/L sodium hydroxide solution

The beverages of the present invention are fruit beverages containing a saccharide-reduced fruit juice, and the degree of the reduction in the amount of saccharides can be specified by the ratio (saccharide concentration-to-acidity ratio) of the saccharide concentration to an acidity of each beverage. Since the beverages of the present invention have a reduced amount of saccharides compared with fruit juices with a non-reduced amount of saccharides, the saccharide concentration-to-acidity ratio in the beverages of the present invention can be set to 0.92 or less, preferably 0.84 or less, 0.82 or less, or 0.80 or less, with respect to a saccharide concentration-to-acidity ratio of a straight fruit juice.

In the beverages of the present invention, the saccharide concentration-to-acidity ratio can also be determined for each type of fruit juice. For example, an orange fruit juice beverage (orange juice) among the beverages of the present invention can be set to have a saccharide concentration-to-acidity ratio of less than 12.8, preferably less than 11.0 or less than 10.0. An Unshu mikan fruit juice beverage (Unshu mikan juice) among the beverages of the present invention can be set to have a saccharide concentration-to-acidity ratio of less than 14.6, preferably less than 12.0 or less than 11.0. A grapefruit fruit juice beverage (grapefruit juice) among the beverages of the present invention can be set to have a saccharide concentration-to-acidity ratio of less than 9.1, preferably less than 7.3 or less than 6.8. A pineapple fruit juice beverage (pineapple juice) among the beverages of the present invention can be set to have a saccharide concentration-to-acidity ratio of less than 16.3, preferably less than 13.9 or less than 13.4.

The beverages of the present invention contain one or more carbohydrate components selected from the group consisting of starch, a starch decomposition product, and trehalose. In the present invention, starch prepared from grains (for example, corn, high-amylose corn, waxy corn, wheat, rice, and peas) or potatoes (for example, potatoes, sweet potatoes, or cassava) can be used as starch. In addition, starch decomposition products (sometimes referred to as “dextrin” in the present invention) mean glucose polymers obtained by hydrolyzing starch using enzymes or acid or through heating. In the present invention, a starch decomposition product with a non-cyclic structure can be used. In the present invention, a starch decomposition product having a DE of greater than 0 and not more than 40 or a starch decomposition product having a DE of greater than 0 and not more than 20 can be used. Here, the “dextrose equivalent (DE)” is also referred to as an equivalent amount of dextrose and is an index of the degree (degree of low molecular weight) of decomposition of a starch decomposition product. DE is a value indicated by the content (percentage) of reducing saccharides quantitatively determined as glucose with respect to solid contents and can be measured through, for example, a Lane-Eynon method.

The lower limit value of the content of carbohydrate components in the beverages of the present invention can be set to 0.005 mass% or 0.010 mass% and the upper limit value thereof can be set to 0.10 mass% or 0.020 mass%. These lower limit values and upper limit values can be arbitrarily combined, and the range of the above-described content can be set to, for example, 0.005 to 0.10 mass% or 0.010 to 0.020 mass%.

The content of carbohydrate components in a beverage can be measured through high-performance liquid chromatography (HPLC method). In addition, the content of carbohydrate components in the beverages of the present invention can be a total value of each of concentrations of starch, a starch decomposition product, and trehalose.

Purified components can be used as carbohydrate components contained in the beverages of the present invention. A crudely purified form may also be used as long as it does not adversely affect flavors of the beverages of the present invention.

The beverages of the present invention can be set to contain oligosaccharides (excluding starch decomposition products). “Oligosaccharides” in the present invention are oligosaccharides having a polymerization degree of 3 to 10, and include lactosucrose, galactooligosaccharides, and fructooligosaccharides such as 1-kestose, nystose, neokestose, and fructofuranosylnystose and preferably include fructooligosaccharides. The beverages of the present invention can be specified as ones containing oligosaccharides at a predetermined concentration. The oligosaccharide concentration in a beverage can be measured through high-performance liquid chromatography (HPLC method).

The oligosaccharide concentration in the beverages of the present invention can be set to 0.1 0 g/100 mL or more in terms of Brix 11°. In addition, the content of oligosaccharides in the beverages of the present invention can be set to 1 to 30 mass%.

The oligosaccharide concentration in the beverages of the present invention can also be determined for each type of fruit juice. For example, the orange fruit juice beverage among the beverages of the present invention can be set to contain oligosaccharides at 0.7 g/100 mL or more (for example, 0.7 to 2.0 g/100 mL) and preferably at 0.9 g/100 mL or more (for example, 0.9 to 1.5 g/100 mL) in terms of Brix 11°.

The grapefruit fruit juice beverage among the beverages of the present invention can be set to contain oligosaccharides at 0.1 g/100 mL or more (for example, 0.1 to 1.0 g/100 mL) and preferably at 0.2 g/100 mL or more (for example, 0.2 to 0.5 g/100 mL) in terms of Brix 9°.

The Unshu mikan fruit juice beverage among the beverages of the present invention can be set to contain oligosaccharides at 0.6 g/100 mL or more (for example, 0.6 to 2.5 g/100 mL) and preferably at 0.9 g/100 mL or more (for example, 0.9 to 2.0 g/100 mL) in terms of Brix 9°.

The pineapple fruit juice beverage among the beverages of the present invention can be set to contain oligosaccharides at 0.5 g/100 mL or more (for example, 0.5 to 3.0 g/100 mL) and preferably at 0.8 g/100 mL or more (for example, 0.8 to 2.0 g/100 mL) in terms of Brix 11°.

Fructooligosaccharides which are oligosaccharides contained in the beverages of the present invention are products obtained by in situ converting of sucrose contained in the fruit juice to fructooligosaccharides through enzymatic treatment in specific aspect of the present invention. That is, the production of fructooligosaccharides in the beverages can be achieved through enzymatic treatment in a step of processing a raw material fruit juice or during or after a step of mixing a raw material fruit juice with other raw materials, as will be described below. Accordingly, the beverages of the present invention can be made so as not to contain fructooligosaccharides added as a raw material.

Beverage additives used for formulating and designing ordinary beverages may be incorporated into the beverages of the present invention. Examples of such additives include sweeteners (including high-intensity sweeteners), acidifiers, seasonings, spices, flavoring agents, colorants, thickeners, stabilizers, emulsifiers, nutrition enhancers, pH adjusters, antioxidants, and preservatives. The above-described beverage additives can be mixed with other raw materials in the mixing step to be described below.

As described above, the beverages of the present invention are fruit juice beverages containing predetermined carbohydrate components. Concentrated beverages and diluted beverages are within the scope of the present invention as long as they contain predetermined carbohydrate components. That is, the beverages of the present invention also include so-called concentrated beverages thicker than 100% fruit juice and so-called diluted beverages thinner than 100% fruit juice.

The Brix values of the beverages of the present invention can be determined based on about 100% of fruit juice and for example, can be set to 6 to 15°Bx (preferably 7 to 13°Bx). The Brix values of the beverages of the present invention can also be determined for each type of fruit juice. The Brix value of the orange fruit juice beverage among the beverages of the present invention can be set to, for example, 8 to 15°Bx and preferably 9 to 13°Bx. The Brix value of the grapefruit fruit juice beverage among the beverages of the present invention can be set to, for example, 6 to 13°Bx and preferably 7 to 11°Bx. The Brix value of the Unshu mikan fruit juice beverage among the beverages of the present invention can be set to, for example, 6 to 13°Bx and preferably 7 to 11°Bx. The Brix value of the pineapple fruit juice beverage among the beverages of the present invention can be set to, for example, 8 to 15°Bx and preferably 9 to 13°Bx.

The proportion of the fruit juice in each beverage of the present invention is not particularly limited. However, the lower limit value (a value of not less than or greater than) thereof can be set to 30%, 40%, 50%, 60%, or 70%, and the upper limit value (a value of not more than or less than) thereof can be set to 150%, 120%, or 100%.

These lower limit values and upper limit values can be arbitrarily combined, and the range of the above-described ratios can be set to, for example, 30 to 150% (preferably 40 to 120% or 50 to 100%). Here, the proportion of a fruit juice refers to a proportion of a fruit juice extract (also generally referred to as 100% juice, straight fruit juice, and 100% fruit juice) in an entire beverage. According to the JAS standards (the Japanese Agricultural Standards for fruit beverages), standards (°Bx) of saccharide refractometer readings for a fruit juice extract are determined for each fruit as shown in Table 1. The proportion of a fruit juice in a beverage can be calculated based on the standards. For example, the Brix value of 100% orange fruit juice is 11°Bx according to the JAS standards. When 10 mass% of concentrated orange fruit juice at 44°Bx is incorporated into a beverage, the proportion of the fruit juice in the beverage is 40%. In calculating the proportion of a fruit juice, when saccharides are added to a fruit juice extract, saccharide refractometer readings for sugars, honey, and the like that have been added may be excluded.

Table 1

Standards (°Bx) of saccharide refractometer readings

| Name of fruit | Standards (°Bx) of saccharide refractometer readings | Name of fruit | Standards (°Bx) of saccharide refractometer readings |
|---|---|---|---|
| Orange | 11 | European pear | 11 |
| Unshu mikan | 9 | Persimmon | 14 |
| Grapefruit | 9 | Quince | 10 |
| Apple | 10 | Japanese plum | 6 |
| Grape | 11 | Apricot | 7 |
| Pineapple | 11 | Cranberry | 7 |
| Peach | 8 | Banana | 23 |
| Natsumikan | 9 | Papaya | 9 |
| Hassaku | 10 | Kiwifruit | 10 |
| Iyokan | 10 | Mango | 13 |
| Ponkan | 11 | Guava | 8 |
| Shiikuwasha | 8 | Passion fruit | 14 |
| Japanese pear | 8 | | |

* In a case of fruit other than the fruit in this table, an average saccaride refractometer reading for an extract of the corresponding fruit is regarded as a standard of the saccharide refractometer reading.

As shown in examples described below, in saccharide-reduced fruit juices, flavor balance deteriorated due to reduction in the amount of saccharides, and deterioration in flavor balance due to reduction in the amount of saccharides was also observed due to heat sterilization for packaging. In all of the beverages of the present invention, the deterioration in flavor balance due to reduction in the amount of saccharides can be ameliorated. That is, according to the present invention, it is possible to ameliorate deterioration in flavor balance of a saccharide-reduced fruit beverage (particularly a packaged saccharide-reduced fruit beverage) due to the reduction in the amount of saccharides. Here, the “flavor balance” means that flavors including “pre-sour taste,” “post-sour taste,” “mellowness,” “swelling,” and “sugariness” are in harmony like those of fruit juices without a saccharide reduction treatment, and the “deterioration in flavor balance” means that flavor balance is biased as compared with a fruit juice without a saccharide reduction treatment and includes a decrease in flavor balance.

### Method for Producing Beverages of Present Invention

The beverages of the present invention can be produced by adding one or more carbohydrate components selected from the group consisting of starch, a starch decomposition product, and trehalose to a saccharide-reduced fruit juice.

The production method of the present invention (especially, a method for producing a fruit beverage containing a saccharide-reduced fruit juice) may further comprise a step (saccharide reduction step) of reducing the amount of saccharides of the fruit beverage. The reduction of the concentration of saccharides (reduction in the amount of saccharides) can be performed by one or more treatments selected from the group consisting of enzymatic treatment, a membrane filtration treatment, a catalyst treatment, and a fermentation treatment. The saccharide reduction step can be carried out in a step of processing a raw material fruit juice or during or after a step of mixing a raw material fruit juice with other raw materials.

Examples of enzymes used for enzymatic treatment in the present invention include a glycosyltransferase using sucrose as a substrate. Examples of glycosyltransferases which are used in the production method of the present invention and uses sucrose as a substrate include fructosyltransferase, levansucrase, dextransucrases, and inulosucrases. One or more of these can be used, and fructosyltransferase is preferable.

Fructosyltransferase used in the production method of the present invention is an enzyme having an activity of producing fructooligosaccharides from sucrose. Commercially available fructosyltransferase can be used in the present invention. In the present invention, fructosyltransferase may be obtained by culturing microorganisms that produce fructosyltransferase and purifying and crudely purifying the enzyme from the cultured product.

Fructosyltransferase having substantially no pectinase activity can be used in the present invention. Here, “having substantially no pectinase activity” means that the enzyme has no activity of causing a remarkable clarification effect and/or viscosity-reduction effect when treating a fruit juice. For example, when an enzymatic treatment test in which orange fruit juice is used is performed, an enzyme is taken as having substantially no pectinase activity in a case where fructooligosaccharides with a saccharide composition ratio of 10% or more are produced and the turbidity after the treatment is maintained at 35% or more as compared with that before the treatment.

In the production method of the present invention, in a case where fructosyltransferase having substantially no pectinase activity is used for enzymatic treatment, the turbidity and/or viscosity of a beverage produced are kept high. The ratio of the turbidity of a fruit juice after enzymatic treatment to the turbidity thereof before the enzymatic treatment, that is, the turbidity maintenance rate, can be set to 35% or more, preferably to 50% or more, and particularly preferably to 70% or more. A fruit juice which has the above-described turbidity maintenance rate and is subjected to enzymatic treatment using fructosyltransferase having substantially no pectinase activity can be used in the present invention.

Fructosyltransferase in the form of a crude enzyme agent can be used in the present invention. Here, the “crude enzyme agent” means a relatively inexpensive and safe reagent or an enzyme agent obtained by separation and extraction means such as filtration membrane separation which is usually used as an enzyme agent sold for industrial production of foods, and does not include an enzyme agent prepared using advanced and high-cost separation and purification means such as fractional purification through liquid chromatography or the like.

In enzymatic treatment using fructosyltransferase in the present invention, 1 U or more of the fructosyltransferase per gram of sucrose in a fruit juice can be added as a guide, and 5 U per gram of sucrose is preferable and 10 U per gram of sucrose is particularly preferable. After adding the enzyme, the mixture is reacted at 25° C. for 4 hours as a guide. The temperature and the time can be appropriately adjusted according to the type of fruit juice or the amount of enzyme added. Note that a reaction at a high temperature for a long period of time causes decomposition of saccharides. In a case of using two or more fruit juices such as mixed juice, either method, that is, a method of mixing fruit juices after respectively subjecting the fruit juices to enzymatic treatment or a method of mixing fruit juices to collectively subject the fruit juices to enzymatic treatment, can be used. In a case of treating concentrated fruit juice, the treatment may be performed at any timing, that is, before, during, or after concentration.

In the present invention, membrane filtration treatment can be carried out on raw material fruit juices. Examples of filtration membranes that can be used include a nanofiltration membrane, a dialysis membrane, an ultrafiltration membrane, and a reverse osmosis membrane, and a nanofiltration membrane is preferable. As the filtration membrane used in the present invention, a membrane of which the transmittance of carbohydrates such as trisaccharides or higher saccharides is lower than that of monosaccharides or disaccharides can be selected. A membrane of which the transmittance of carbohydrates such as trisaccharides or higher saccharides is lower than that of monosaccharides and disaccharides and the difference in transmittance is 10% or more can be preferably selected, and a membrane having a fractional molecular weight of about 100 to 1,000 Da can be more preferably selected.

In the present invention, the amount of saccharides may be reduced by carrying out either enzymatic treatment or membrane filtration treatment alone or in combination of these treatments. In a case where the enzymatic treatment and the membrane filtration treatment are carried out in combination, the membrane filtration treatment can be carried out on a fruit juice before or after being subjected to the enzymatic treatment using an enzyme or may be carried out simultaneously to the enzymatic treatment using an enzyme.

The beverages of the present invention may further include a step of adjusting the content of carbohydrate components in the beverages to 0.005 to 0.10 mass%. Plural kinds of carbohydrate components may be used in the production method of the present invention. In a case where a beverage contains plural kinds of carbohydrate components, the content of each of the carbohydrate components may be adjusted independently or at the same time. The adjustment may be carried out in any order in the case where it is carried out independently. In the production method of the present invention, adjustment of the content of carbohydrate components can be carried out on a fruit juice before or after being subjected to a saccharide reduction treatment, or may be carried out simultaneously to a saccharide reduction treatment.

Either a straight fruit juice or concentrated fruit juice may be used as raw materials used in the production method of the present invention. In a case where the concentration of a desired beverage is low, a diluted fruit juice mixed with water or other drinkable liquids can be used as a raw material. In addition, the raw materials used in the production method of the present invention may be used as a mixed juice of two or more kinds of fruit juices.

In the production method of the present invention, process other than the saccharide reduction treatment and the adjustment of the concentration of aroma components described above can be carried out according to a well-known production procedure for fruit beverages. That is, a squeezing step can be carried out before a saccharide reduction treatment to prepare a fruit juice. In a case of using a commercially available concentrate or paste as a raw material, the squeezing step can be omitted. In addition, in a mixing step, other raw materials such as additives can be mixed with a fruit juice which has been subjected to a saccharide reduction treatment The concentration of aroma components may be adjusted in the mixing step or may be adjusted before or after the mixing step. The mixed liquid obtained in the mixing step can be packed in a container through a sterilization step and a filling step. Beverages of the present invention packed in containers can be subjected to a sealing step and a cooling step as necessary.

### Method for Improving Flavor of Present Invention

According to another aspect of the present invention, there is provided a method for improving a flavor of a saccharide-reduced fruit beverage, the method comprising: adding one or more carbohydrate components selected from the group consisting of starch, a starch decomposition product, and trehalose to the beverage. The method for improving a flavor of the present invention can be carried out according to the description of the beverages of the present invention and the method for producing the same. In the method for improving a flavor of the present invention, the deterioration in flavor balance due to reduction in the amount of saccharides in a saccharide-reduced fruit juice can be prevented.

### EXAMPLES

The present invention will be described in more detail based on the following examples, but the present invention is not particularly limited to these examples.

### Measurement of Saccharide Concentration, Saccharide Composition, Total Saccharide Concentration, and Brix

In the following examples, the saccharide concentration (monosaccharides, disaccharides, and oligosaccharides) in a sample beverage was analyzed according to an absolute calibration curve method in which high-performance liquid chromatography (HPLC method) was used. Specifically, the measurement was carried out as follows.

A sample solution was diluted with water to prepare a solution containing about 1% of saccharides. Subsequently, the solution was filtered through a syringe filter, and was then subjected to analysis using HPLC (manufactured by JASCO Corporation) according to the conditions disclosed in WO 2019/004054 to calculate the saccharide concentration (concentration of each saccharide, concentration of saccharides, and total saccharide concentration). The saccharide concentration was a total value of the monosaccharide concentration and a disaccharide concentration.

### HPLC Analysis Conditions

Column: YMC-Pack Polyamine II (YMC America)

Mobile phase: 67% (v/v) Acetonitrile solution

Column temperature: 30° C.

Flow rate: 1.0 mL/minute

Detection: Differential refractive index detector

### Measurement of Acidity

"Acidities" in sample beverages in the following examples were calculated based on an acidity measurement method defined in the Japanese Agricultural Standards (Aug. 8, 2006, Ministry of Agriculture, Forestry and Fisheries Notification No. 1127) as described above. Specifically, 10.0 g of a sample was dispensed into a beaker, and the sample was diluted to 150 mL with water. Subsequently, titration was performed with a 0.10 mol/L NaOH solution to calculate an acidity from the titration amount of the NaOH solution. An end point was detected according to an automatic potentiometric titrator (AT-610, Kyoto Electronics Manufacturing Co., Ltd.).

The Brix value was measured using a saccharimeter (Rx-5000α, Atago Co., Ltd.).

### Example 1: Effect of Various Carbohydrate Components on Flavor of Saccharide-Reduced Orange Fruit Juice

### Preparation of Sample Beverages

Orange fruit juice (65°Bx, Cutrale) was diluted to 45°Bx. 100 g of the diluted orange fruit juice was dispensed into a 200 mL beaker. Subsequently, fructosyltransferase (derived from the genus Aspergillus, manufactured by SHINNIHON CHEMICALS Corporation, sometimes simply referred to as “FTase” below) was added thereto so as to have a concentration of 10 U per gram of sucrose. The mixture was sufficiently stirred so as to become uniform and was then allowed to stand at 25° C. for 4 hours to cause an enzymatic reaction. After the completion of the enzymatic reaction, the resultant was diluted to 11°Bx. Then, the diluted resultant was used for filling a steel can and subjected to a heat treatment at 80° C. for 10 minutes to deactivate the enzyme, and a sample beverage (sample number 1) with a reduced saccharide concentration was prepared. Subsequently, dextrin (L-SPD, DE value of 16.5, Showa Sangyo Co., Ltd., the same applies hereinafter), starch (dogtooth violet starch (potato starch, unprocessed starch), Maruboshi Co., Ltd., the same applies hereinafter), trehalose (TOMIZ, Cuoca Planning Co., Ltd.), cyclodextrin (Celldex B-100, Nihon Shokuhin Kako Co., Ltd.), and indigestible dextrin (E-fiber, Mitsubishi Corporation) was added as a carbohydrate component to the saccharide-reduced beverage (sample number 1) to have a concentration (mass%) shown in Table 3, and saccharide-reduced beverages (sample numbers 2 to 10) into which each carbohydrate component was incorporated were prepared.

### Evaluation of Flavor

Flavors (specifically, the presence or absence of an uncomfortable feeling compared to a case where orange fruit juice with a general composition was drunk) of the sample beverage (sample number 1) prepared in (1) above and orange fruit juice (11°Bx, a beverage with a non-reduced amount of saccharides) having a general composition and a saccharide concentration of 8.33 g/100 mL (disaccharide concentration of 3.99 g/100 mL) were evaluated. It was scored A in a case where there was no uncomfortable feeling, and it was scored C in a case where there was an uncomfortable feeling.

### Sensory Evaluation

The sample beverages (sample numbers 1 to 10) prepared in (1) above were used for sensory evaluation. The sensory evaluation was carried out by 5 trained panelists, and the evaluation items were “pre-sour taste,” “post-sour taste,” “mellowness,” “swelling,” “sugariness,” and “overall deliciousness.” The sample number 1 was used as a control beverage, and how far the sample beverages (sample numbers 2 to 10) were from the control beverage (how much the evaluation items of the sample beverages increased or decreased) was evaluated according to the following evaluation criteria. The following numerical values were given a positive sign when each evaluation item increased and given a negative sign when each evaluation item decreased. The score of the control beverage was set to 10, and the score was given by each panelist by adding a numerical value with a sign to 10.

### Evaluation Criteria

0 to 0.4: There was almost no difference in increase or decrease compared to the control beverage.

0.5 to 1.0: A difference in increase or decrease was felt when carefully compared to the control beverage.

1.1 to 2.0: A difference in increase or decrease was clearly felt compared to the control beverage.

From 2.1: A difference in increase or decrease was felt without comparing with the control beverage.

The panelists scored the sample beverages to the first decimal place, an average score of all the panelists was calculated, and a value obtained by dividing the average score by 10 was regarded as a number of evaluation points (the number of evaluation points of the control beverage was 1). A number of evaluation points exceeding 0.05 was determined to be “effective.” In addition, in a case where there were comments about the beverages, they are shown in the tables. Here, the “pre-sour taste” refers to the intensity of sour taste from the top to the middle. The “post-sour taste” refers to the intensity of sour taste felt at the end. The “mellowness” refers to spread of taste when a beverage is taken into the mouth. The “swelling” refers to complexity of taste when a beverage is taken into the mouth. The “sugariness” refers to the intensity of sweetness. The “overall deliciousness” refers to closeness (weakness of an uncomfortable feeling) to a fruit juice which has a general composition and a non-reduced saccharide concentration.

### Results

The results are as shown in Tables 2 and 3.

Table 2

Concentration of various components and saccharide concentration-to-acidity ratio of fruit juices with reduced and non-reduced amount of saccharides, and flavor evaluation results

| | | |
|---|---|---|
| | Beverage with non-reduced amount of saccharides | Beverage with reduced amount of saccharides (sample number 1) |
| Monosaccharide concentration (g/100 mL) | 4.34 | 5.57 |
| Disaccharide concentration (g/100 mL) | 3.99 | 0.90 |
| Saccharide concentration (g/100 mL) | 8.33 | 6.47 |
| Acidity | 0.65 | 0.66 |
| Saccharide concentration-to-acidity ratio | 12.8 | 9.8 |
| Flavor | A | C |

Table 3-1

Concentration of carbohydrate components in saccharide-reduced orange fruit juice and sensory evaluation results

| | | | | | | |
|---|---|---|---|---|---|---|
| | Sample number 1 (control beverage) | Sample number 2 | Sample number 3 | Sample number 4 | Sample number 5 | Sample number 6 |
| Concentration (mass%) of carbohydrate components | | 0.005 of dextrin | 0.010 of dextrin | 0.050 of dextrin | 0.100 of dextrin | 0.200 of dextrin |
| Pre-sour taste | 1 | 0.85 | 0.80 | 0.68 | 0.67 | 0.67 |
| Post-sour taste | 1 | 0.87 | 0.82 | 0.70 | 0.67 | 0.67 |
| Mellowness | 1 | 1.08 | 1.13 | 1.20 | 1.23 | 1.20 |
| Swelling | 1 | 1.04 | 1.08 | 1.13 | 1.13 | 1.10 |
| Sugariness | 1 | 1.12 | 1.21 | 1.30 | 1.20 | 1.17 |
| Overall deliciousness | 1 | 1.13 | 1.25 | 1.37 | 1.27 | 1.00 |
| Comment | | | | | | Acridity is felt |

Table 3-2

Concentration of carbohydrate components in saccharide-reduced orange fruit juice and sensory evaluation results (continued)

| | | | | |
|---|---|---|---|---|
| | Sample number 7 | Sample number 8 | Sample number 9 | Sample number 10 |
| Concentration (mass%) of carbohydrate components | 0.100 of starch | 0.100 of trehalose | 0.100 of indigestible dextrin | 0.100 of cyclodextrin |
| Pre-sour taste | 0.73 | 0.83 | 0.82 | 0.82 |
| Post-sour taste | 0.77 | 0.82 | 0.88 | 0.87 |
| Mellowness | 1.17 | 1.17 | 1.00 | 1.00 |
| Swelling | 1.07 | 1.08 | 0.94 | 1.00 |
| Sugariness | 1.10 | 1.17 | 1.08 | 1.00 |
| Overall deliciousness | 1.17 | 1.17 | 0.92 | 0.87 |
| Comment | | | Strong powdery feeling | Iron-like taste |

It was confirmed from the results of Table 2 that the flavor balance in the orange fruit juice (11°Bx) with a reduced saccharide concentration which had a saccharide concentration-to-acidity ratio of less than 12.8 deteriorated compared to that in the orange fruit juice (beverage with a non-reduced amount of saccharides) which had a general composition and a non-reduced saccharide concentration. It was confirmed from the results of Table 3 that the deteriorated flavor could be improved by adding a predetermined amount of dextrin, starch, or trehalose to the orange fruit juice (11°Bx) with a reduced saccharide concentration which had a saccharide concentration-to-acidity ratio of less than 12.8. On the other hand, although the flavor balance improved by adding indigestible dextrin or cyclodextrin to the orange fruit juice with a reduced saccharide concentration, off-taste was pointed out. From these results, it was suggested that carbohydrates other than indigestible dextrin and cyclodextrin aresuitable as carbohydrate components contained in the beverages of the present invention.

### Example 2: Effect of Various Carbohydrate Components on Flavor of Saccharide-Reduced Orange Fruit Juice After Heat Sterilization

### Preparation of Sample Beverages

Sample beverages were prepared according to the method described in (1) of Example 1. A beverage with a non-reduced amount of saccharides was prepared, and a sample beverage (sample number 11) having a reduced saccharide concentration was prepared.

### Packaging and Sterilizing Beverages

A retort bottle was filled with the sample beverage (sample number 11) prepared in (1) above, and the sample beverage was sterilized with a pasteurizer at 65° C. for 10 minutes to prepare a packaged sample beverage (sample number 12). Subsequently, dextrin was added to the packaged sample beverage (sample number 12) to the concentration (mass%) shown in Table 5 to prepare a packaged sample beverage (sample number 13) to which dextrin was added.

### Evaluation of Flavor

Evaluation of flavors of the sample beverages (sample numbers 11 and 12) prepared in (1) and (2) above and the orange fruit juice (11°Bx, the beverage with a non-reduced amount of saccharides) having a general composition and a saccharide concentration of 8.33 g/100 mL (disaccharide concentration of 3.99 g/100 mL) was performed according to the method described in (2) of Example 1. In addition, in a case where there were comments about the beverages, they were shown in the tables.

### Sensory Evaluation

The sample beverages (sample numbers 11 and 13) prepared in (1) and (2) above were used for sensory evaluation. The sensory evaluation was carried out by 5 trained panelists according to the method and the criteria described in (3) of Example 1.

### Results

The results are as shown in Tables 4 and 5.

Table 4

Saccharide concentration and saccharide concentration-to-acidity ratio of saccharide-reduced orange fruit juice, and flavor evaluation results

| | | | |
|---|---|---|---|
| | Beverage with non-reduced amount of saccharides | Sample number 11 | Sample number 12 |
| Monosaccharide concentration (g/100 mL) | 4.34 | 4.90 | 4.90 |
| Disaccharide concentration (g/100 mL) | 3.99 | 1.55 | 1.55 |
| Saccharide concentration (g/100 mL) | 8.33 | 6.45 | 6.45 |
| Acidity | 0.65 | 0.66 | 0.66 |
| Saccharide concentration-to-acidity ratio | 12.8 | 9.8 | 9.8 |
| Flavor | A | C | C |
| Comment | | Strong sour taste is felt | Strong, sharp sour taste is felt |

Table 5

Polysaccharide concentration of packaged saccharide-reduced fruit beverages and sensory evaluation results

| | Sample number 12 | Sample number 13 |
|---|---|---|
| Concentration (mass%) of dextrin | | 0.010 |
| Pre-sour taste | 1 | 0.74 |
| Post-sour taste | 1 | 0.77 |
| Mellowness | 1 | 1.24 |
| Swelling | 1 | 1.13 |
| Sugariness | 1 | 1.25 |
| Overall deliciousness | 1 | 1.32 |

It was confirmed from the results of Table 4 that the flavor balance in the sterilized orange fruit juice (11°Bx) (sample number 12) which had a reduced saccharide concentration and a saccharide concentration-to-acidity ratio of less than 12.8 deteriorated compared to that in the orange fruit juice (beverage with a non-reduced amount of saccharides) which had a general composition and that sour taste was more sharply felt compared to the orange fruit juice (sample number 11) with a reduced saccharide concentration which had not been subjected to sterilization. It was confirmed from the results of Table 5 that the deteriorated flavor of the beverage (sample number 13) obtained by adding a predetermined amount of dextrin to the sterilized orange fruit juice (11°Bx) which had a reduced saccharide concentration and a saccharide concentration-to-acidity ratio of less than 12.8 could be improved and that the improvement in the deteriorated flavor due to dextrin was more effective compared to the fruit juice (sample number 3) which had not been sterilized.

### Example 3: Effect of Various Carbohydrate Components on Flavor of Saccharide-Reduced Grapefruit Fruit Juice, Unshu Mikan Fruit Juice, and Pineapple Fruit Juice

### Preparation of Sample Beverages

Enzymatic treatment was performed according to the method described in (1) of Example 1 except that grapefruit fruit juice (61°Bx, Citrus World, Inc., a beverage with a non-reduced amount of saccharides), Unshu mikan fruit juice (64°Bx, YI HAI HSIAN FOOD MATERIALS CO., LTD., a beverage with a non-reduced amount of saccharides), and pineapple fruit juice (60°Bx, Dole Food Company, Inc., a beverage with a non-reduced amount of saccharides) were used to prepare a grapefruit beverage (sample number 14), an Unshu mikan beverage (sample number 15) and pineapple beverage (sample number 16) with a reduced saccharide concentration. Brix values of the beverages were adjusted to 9°Bx for the grapefruit fruit juice and the Unshu mikan fruit juice and 11°Bx for the pineapple fruit juice. Subsequently, dextrin or starch was added to the sample beverages (sample numbers 14 to 16) to the concentration (mass%) shown in Tables 7 to 9 to prepare saccharide-reduced beverages (sample numbers 17 to 23) into which carbohydrate components were incorporated.

### Evaluation of Flavor

Evaluation of flavors of the sample beverages (sample numbers 14 to 16) prepared in (1) above, the grapefruit fruit juice (9°Bx, control beverage) having a general composition and a saccharide concentration of 6.8 g/100 mL (disaccharide concentration of 2.14 g/100 mL), the Unshu mikan fruit juice (9°Bx, control beverage) having a general composition and a saccharide concentration of 14.6 g/100 mL (disaccharide concentration of 4.05 g/100 mL), and the pineapple fruit juice (11°Bx, control beverage) having a general composition and a saccharide concentration of 9.93 g/100 mL (disaccharide concentration of 5.61 g/100 mL) was performed according to the method described in (2) of Example 1.

### Sensory Evaluation

The sample beverages (sample numbers 14 to 23) prepared in (1) above were used for sensory evaluation. The sensory evaluation was carried out by 4 trained panelists according to the method and the criteria described in (3) of Example 1.

### Results

The results are as shown in Tables 6 to 9.

Table 6

Concentration of varoius components and saccharide concentration-to-acidity ratio of fruit juices with reduced and non-reduced amount of saccharides, and flavor evaluation results

| | | | | | | |
|---|---|---|---|---|---|---|
| | Beverage with non-reduced saccharid es (grapefrui t) | Sample number 14 (grapefrui t) | Beverage with non-reduced saccharid es (Unshu mikan) | Sampl e numbe r 15 (Unsh u mikan ) | Beverage with non-reduced saccharid es (pineappl e) | Sample number 16 (pineappl e) |
| Monosacchari de concentration (g/100 mL) | 4.42 | 5.30 | 2.67 | 4.42 | 4.32 | 6.44 |
| Disaccharide concentration (g/100 mL) | 2.14 | 0.64 | 4.05 | 0.78 | 5.61 | 1.68 |
| Saccharide concentration (g/100 mL) | 6.56 | 5.94 | 6.72 | 5.20 | 9.93 | 8.12 |
| Acidity | 0.96 | 0.96 | 0.46 | 0.46 | 0.61 | 0.61 |
| Saccharide concentration-to-acidity ratio | 6.8 | 6.2 | 14.6 | 11.3 | 16.3 | 13.3 |
| Flavor | A | C | A | C | A | C |

Table 7

Concentration of carbohydrate components in saccharide-reduced grapefruit fruit juice and sensory evaluation results

| | Sample number 14 (control beverage) | Sample number 17 | Sample number 18 | Sample number 19 |
|---|---|---|---|---|
| Concentration of carbohydrate components (mass%) | | 0.010 of dextrin | 0.100 of dextrin | 0.100 of starch |
| Pre-sour taste | 1 | 0.88 | 0.87 | 0.84 |
| Post-sour taste | 1 | 0.86 | 0.85 | 0.83 |
| Mellowness | 1 | 1.13 | 1.23 | 1.22 |
| Swelling | 1 | 1.10 | 1.20 | 1.15 |
| Sugariness | 1 | 1.13 | 1.17 | 1.17 |
| Overall deliciousness | 1 | 1.13 | 1.23 | 1.23 |

Table 8

Concentration of carbohydrate components in saccharide-reduced Unshu mikan fruit juice and sensory evaluation results

| | Sample number 15 (control beverage) | Sample number 20 | Sample number 21 | Sample number 22 |
|---|---|---|---|---|
| Concentration of carbohydrate components (mass%) | | 0.010 of dextrin | 0.100 of dextrin | 0.100 of starch |
| Pre-sour taste | 1 | 0.88 | 0.83 | 0.82 |
| Post-sour taste | 1 | 0.88 | 0.83 | 0.80 |
| Mellowness | 1 | 1.10 | 1.13 | 1.27 |
| Swelling | 1 | 1.07 | 1.07 | 1.10 |
| Sugariness | 1 | 1.03 | 1.10 | 1.22 |
| Overall deliciousness | 1 | 1.17 | 1.25 | 1.22 |

Table 9

Concentration of carbohydrate components in saccharide-reduced pineapple fruit juice and sensory evaluation results

| | Sample number 16 (control beverage) | Sample number 23 |
|---|---|---|
| Concentration of carbohydrate components (mass%) | | 0.050 of dextrin |
| Pre-sour taste | 1 | 0.80 |
| Post-sour taste | 1 | 0.72 |
| Mellowness | 1 | 1.14 |
| Swelling | 1 | 1.04 |
| Sugariness | 1 | 0.98 |
| Overall deliciousness | 1 | 1.10 |

It was confirmed from the results of Table 6 that the flavor balance in the grapefruit fruit juice (9°Bx) with a reduced saccharide concentration which had a saccharide concentration-to-acidity ratio of less than 6.8, the Unshu mikan fruit juice (9°Bx) with a reduced saccharide concentration which had a saccharide concentration-to-acidity ratio of less than 14.6, and the pineapple fruit juice (11°Bx) with a reduced saccharide concentration which had a saccharide concentration-to-acidity ratio of less than 16.3 deteriorated compared to each of the fruit juices (beverages with a non-reduced amount of saccharides) having a general composition. In addition, it was confirmed from the results of Table 7 that the deteriorated flavor could be improved by adding a predetermined amount of dextrin or starch to the grapefruit fruit juice (9°Bx) with a reduced saccharide concentration which had a saccharide concentration-to-acidity ratio of less than 6.8. It was confirmed from the results of Table 8 that the deteriorated flavor could be improved by adding a predetermined amount of dextrin or starch to the Unshu mikan fruit juice (9°Bx) with a reduced saccharide concentration which had a saccharide concentration-to-acidity ratio of less than 14.6. It was confirmed from the results of Table 9 that the deteriorated flavor could be improved by adding a predetermined amount of dextrin to the pineapple fruit juice (11°Bx) with a reduced saccharide concentration which had a saccharide concentration-to-acidity ratio of less than 16.3.

### Example 4: Effect of Dextrin on Flavor of Orange Fruit Juice

### Preparation of Sample Beverages

Concentrated orange fruit juice (65°Bx, Cutrale) was adjusted to have 11°Bx to produce orange fruit juice (beverage with a non-reduced amount of saccharides) which had a general composition and a saccharide concentration of 8.4 g/100 mL. Subsequently, L-ascorbic acid was added to the orange fruit juice to the concentrations (mass%) shown in Table 10 to prepare sour taste-imparted beverages (sample numbers 24 to 27). Subsequently, dextrin was added to the sour taste-imparted beverage (sample number 26), to which 0.50 mass% of ascorbic acid is added, to the concentration (mass%) shown in Table 11 to prepare beverages (sample numbers 28 to 31) into which a carbohydrate component (dextrin) was incorporated.

### Evaluation of Flavor

Evaluation of flavors of the sample beverages (sample numbers 24 and 27) prepared in (1) above and the orange fruit juice (11°Bx, the beverage with a non-reduced amount of saccharides) having a general composition was performed according to the method described in (2) of Example 1.

### Sensory Evaluation

The sample beverages (sample numbers 26 and 28 to 31) prepared in (1) above were used for sensory evaluation. The sensory evaluation was carried out by 3 trained panelists according to the method and the criteria described in (3) of Example 1.

### Results

The results are as shown in Tables 10 and 11.

Table 10

Concentration of various components and saccharide concentration-to-acidity ratio of sour taste-imparted fruit juice and fruit juice with non-reduced amount of saccharides, and flavor evaluation results

| | | | | | |
|---|---|---|---|---|---|
| | Beverage with non-reduced amount of saccharides | Sample number 24 | Sample number 25 | Sample number 26 | Sample number 27 |
| Saccharide concentration (g/100 mL) | 8.4 | 8.4 | 8.4 | 8.4 | 8.4 |
| Concentration (mass%) of ascorbic acid | 0 | 0.05 | 0.10 | 0.50 | 1.00 |
| Acidity | 0.65 | 0.67 | 0.69 | 0.83 | 0.95 |
| Saccharide concentration-to-acidity ratio | 12.9 | 12.5 | 12.2 | 10.1 | 8.8 |
| Flavor | A | A | B | C | C |

Table 11

Concentration of carbohydrate component in sour taste-imparted fruit juice and flavor evaluation results

| | | | | | |
|---|---|---|---|---|---|
| | Sample number 26 (control beverage) | Sample number 28 | Sample number 29 | Sample number 30 | Sample number 31 |
| Concentration (mass%) of dextrin | | 0.010 | 0.050 | 0.100 | 0.200 |
| Pre-sour taste | 1 | 0.88 | 0.85 | 0.75 | 0.84 |
| Post-sour taste | 1 | 0.96 | 0.89 | 0.83 | 0.94 |
| Mellowness | 1 | 1.07 | 1.10 | 1.15 | 1.03 |
| Swelling | 1 | 1.04 | 1.10 | 1.13 | 1.09 |
| Sugariness | 1 | 1.08 | 1.12 | 1.15 | 1.11 |
| Overall deliciousness | 1 | 1.09 | 1.13 | 1.16 | 0.95 |
| Comment | | | | | Bitter taste, odd taste, and unpleasant irritation to the tongue |

It was confirmed from the results of Table 10 that the flavor balance in the orange fruit juice (11°Bx) having a saccharide concentration-to-acidity ratio of less than 12.5 deteriorated compared to that in the orange fruit juice (beverage with a non-reduced amount of saccharides) having a general composition. It was confirmed from the results of Table 11 that the deteriorated flavor could be improved by adding a predetermined amount of dextrin to the orange fruit juice (11°Bx) having a saccharide concentration-to-acidity ratio of less than 12.5.

### Example 5: Effect of Fructooligosaccharides and Dextrin on Flavor of Orange Fruit Juice

### Preparation of Sample Beverages

Ascorbic acid was added to orange fruit juice (11°Bx) having a general composition and a saccharide concentration of 8.33 g/100 mL to a concentration of 0.50 mass% to prepare a beverage (sour taste-imparted beverage) having a saccharide concentration-to-acidity ratio changed. Subsequently, fructooligosaccharides (Meioligo-P, Meiji Food Materia Co., Ltd.) were added to the beverage to the concentration (mass%) shown in Table 12, and then the mixture was adjusted to have 11°Bx to prepare a sample beverage (sample number 32). Subsequently, dextrin was added to the sample beverage (sample number 32) to the concentration (mass%) shown in Table 13 to prepare a sample beverage (sample number 33) into which a carbohydrate component (dextrin) was incorporated.

### Sensory Evaluation

The sour taste-imparted beverage and the sample beverages (sample numbers 32 and 33) prepared in (1) above were used for sensory evaluation. The sensory evaluation was carried out by 4 trained panelists according to the method and the criteria described in (3) of Example 1.

### Results

The results are as shown in Tables 12 and 13.

Table 12

Concentration of various components and saccharide concentration-to-acidity ratio of sour taste-imparted fruit juice

| | Sour taste-imparted beverage | Sample number 32 |
|---|---|---|
| Saccharide concentration (g/100 mL) | | 7.63 |
| Concentration (mass%) of fructooligosaccharides | 0 | 15.0 |
| Acidity | 0.83 | 0.78 |
| Saccharide concentration-to-acidity ratio | 10.1 | 9.8 |

Table 13

Concentration of various components of sour taste-imparted fruit juice and sensory evaluation results

| | Sour taste-imparted fruit juice | Sample number 32 | Sample number 33 |
|---|---|---|---|
| Concentration (mass%) of dextrin | 0 | 0 | 0.050 |
| Concentration (mass%) of fructooligosaccharides | 0 | 15.0 | 15.0 |
| Pre-sour taste | 1 | 1.02 | 0.95 |
| Post-sour taste | 1 | 0.98 | 0.80 |
| Mellowness | 1 | 1 | 1.12 |
| Swelling | 1 | 1 | 1.10 |
| Sugariness | 1 | 1.1 | 1.18 |
| Overall deliciousness | 1 | 1 | 1.14 |

It was confirmed from the results of Tables 12 and 13 that the deteriorated flavor was not significantly improved by adding fructooligosaccharides to the high-acidity orange fruit juice (11°Bx). On the other hand, it was confirmed that the deteriorated flavor could be improved by adding fructooligosaccharides and dextrin to the high-acidity orange fruit juice (11°Bx) compared to the case where fructooligosaccharides were added.

### Example 6: Effect of Dextrin on Flavor of Fruit Juice With Low Orange Content

### Preparation of Sample Beverages

Orange fruit juice (65°Bx, Cutrale) having a general composition was mixed with enzyme-treated orange fruit juice (45°Bx) obtained by performing an enzymatic reaction according to the method described in (1) of Example 1 and then deactivating an enzyme through a heat treatment at 95° C. for 30 seconds to prepare orange fruit juice having a saccharide concentration of 5.5 g/100 mL and a saccharide concentration-to-acidity ratio of 8.5. Subsequently, the orange fruit juice was adjusted to have 5.5°Bx (the proportion of the fruit juice being 50%) to prepare a beverage with a low fruit juice content which was regarded as a control beverage (a saccharide concentration of 2.75 g/100 mL and a saccharide concentration-to-acidity ratio of 8.3). Subsequently, dextrin was added to the control beverage to the concentration (mass%) shown in Table 14 to prepare a sample beverage (sample number 34, saccharide concentration of 2.75 g/100 mL, and saccharide concentration-to-acidity ratio of 8.3) into which a carbohydrate component (dextrin) was incorporated.

### Sensory Evaluation

The sample beverage (sample number 34) prepared in (1) above and the control beverage were used for sensory evaluation. The sensory evaluation was carried out by 3 trained panelists according to the method and the criteria described in (3) of Example 1.

### Results

The results are as shown in Table 14.

Table 14

Concentration of carbohydrate components of fruit juice with low orange content and sensory evaluation results

| | Control beverage | Sample number 34 |
|---|---|---|
| Concentration (mass%) of dextrin | | 0.050 |
| Pre-sour taste | 1 | 0.84 |
| Post-sour taste | 1 | 0.80 |
| Mellowness | 1 | 1.10 |
| Swelling | 1 | 0.98 |
| Sugariness | 1 | 0.96 |
| Overall deliciousness | 1 | 1.02 |

It was confirmed from the results of Table 14 that the flavor could be improved by adding a dextrin to the fruit juice (5.5°Bx) with a low orange content which had a saccharide concentration-to-acidity ratio of less than 12.5.

1. A fruit beverage in which a ratio (saccharide concentration-to-acidity ratio) of a saccharide concentration to an acidity of the beverage is 0.92 or less with respect to a saccharide concentration-to-acidity ratio of a straight fruit juice, the fruit beverage comprising:
one or more carbohydrate components selected from the group consisting of starch, a starch decomposition product, and trehalose.

2. A fruit beverage containing a saccharide-reduced fruit juice, the fruit beverage comprising:
one or more carbohydrate components selected from the group consisting of starch, a starch decomposition product, and trehalose.

3. The fruit beverage according to claim 1,
wherein a content of carbohydrate components in the beverage is 0.005 to 0.10 mass%.

4. The beverage according to claim 1,
wherein fruit includes one or more selected from the group consisting of orange, grapefruit, Unshu mikan, and pineapple.

5. The fruit beverage according to claim 4,
wherein an oligosaccharide concentration of the beverage is 0.10 g/100 mL or more in terms of Brix 11°.

6. The beverage according to claim 1,
wherein a proportion of the fruit juice is 30% or more.

7. The beverage according to claim 1, which is a packaged beverage.

8. A method for producing the fruit beverage according to claim 1, the method comprising:
adding one or more carbohydrate components selected from the group consisting of starch, a starch decomposition product, and trehalose to the saccharide-reduced fruit juice.

9. The production method according to claim 8, further comprising:
adjusting a content of carbohydrate components in the beverage to 0.005 to 0.10 mass%.

10. The production method according to claim 8, further comprising:
a step of reducing an amount of saccharides of a raw material fruit juice.

11. The production method according to claim 10,
wherein the step of reducing an amount of saccharides is performed by one or more treatments selected from the group consisting of an enzyme treatment, a membrane filtration treatment, a catalyst treatment, and a fermentation treatment.

12. The production method according to claim 8,
wherein fruit includes one or more selected from the group consisting of orange, grapefruit, Unshu mikan, and pineapple.

13. A method for improving flavor of a fruit beverage containing a saccharide-reduced fruit juice, the method comprising:
adding one or more carbohydrate components selected from the group consisting of starch, a starch decomposition product, and trehalose to the beverage.

14. The method for improving flavor according to claim 13, wherein the fruit beverage is a packaged beverage.
